(19) United States
(12) Patent Application Publication
(10) Pub. No.: US 2010/0229008 A1
(43) Pub. Date: Sep. 9, 2010

(54) Sound Effect Power Supply Configuration

(76) Inventors: Tsuoe-Hsiang Liao, Hsinchu (TW); Bing-Ling Fan, Hsinchu (TW); Chwai-San Tseng, Chungli (TW)

Correspondence Address: LIN & ASSOCIATES INTELLECTUAL PROPERTY, INC., P.O. BOX 2339, SARATOGA, CA, 95070-0339, US

(21) Appl. No.: 12/399,021

(22) Filed: Mar. 6, 2009

(51) Int. Cl. G06F 1/26; H04R 5/00

(52) U.S. Cl. 713/310; 381/1

(57) ABSTRACT

A sound effect power supply configuration includes a USB power supply source, an external audio source, a sound effect unit and an external speaker, wherein the USB power input terminal provides sound effect unit USB power source, for the sound effect unit after obtaining USB power source may receive the audio signals output by the external audio source, and after appropriately processing the audio, may drive the external speaker to generate sounds having high quality sound effect.

### BACKGROUND OF THE INVENTION

1. Field of the Invention

The present invention relates generally to a sound effect power supply configuration, and more particularly, to a sound effect power supply configuration using USB power source supplied by a USB port as a power source in the functional blocks of an audio unit.

2. The Prior Art

As a rapid development of the electronic technology, the consumer electronic devices with a function of playing speech sound or music have been popularized increasingly, such as an MP3 (MPEG 1 Layer 3) player, a CD (compact disk) player and a DVD (digital versatile disc) player, and even more popularizing cell phones are also built in the function of playing speech sound or music with time.

Therefore, users may download MP3 songs from the Internet and store them into an MP3 player or a cell phone, use an earphone to receive the audio signals output by the MP3 player or the cell phone to listen to music. In addition, users may also play music by playing a CD storing music or a DVD storing video and audio data through a CD player or a DVD player, respectively, to conveniently enjoy the music. However, in general, the output speakers of an MP3 player, a CD player, a DVD player or a cell phone have lower output power, so the sound quality is poor, which is a serious defect for listening to music as entertainment. Although a small speaker may amplify music directly, the sound effect is poor and the volume is not large, the improving effects are very limited in practical. Generally, it is necessary to use a speaker with an external power source for fully solving the problem of sound quality. To connect to an ordinary socket, it often causes a great inconvenience to users. Especially to those users who use computers for long time, they need to place additional power supply receptacles in the limited space of their tables. However, the USB port itself of a cell phone, a laptop computer, a computer or other electronic devices may provide a power source of 5V. It is such a waste for not using the said power source but looking for an additional socket.

### SUMMARY OF THE INVENTION

The main object of the present invention is to provide a sound effect power supply configuration, which includes a USB power supply source, an external audio source, a sound effect unit and an external speaker, wherein the USB power input terminal provides sound effect unit USB power source, for the sound effect unit after obtaining USB power source may receive the audio signals output by the external audio source, and after appropriately processing the audio, may drive the external speaker to generate sounds having high quality sound effect.

Another object of the present invention is to provide a sound effect power supply configuration, which includes a USB power supply source, an external audio source, a sound effect unit and an external speaker, wherein the sound effect unit has a 3D surround, an equalizer, a bass booster, a sound expander, and a sound wider, for audio processing and improving the sound quality.

Hence, the present invention may solve the defects of the prior art, by adequately using a USB port of a cell phone, a laptop computer, a computer or other electronic devices for the USB port itself may provide a power source of 5V.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a sound effect power supply configuration according to the present invention; and

FIG. 2 is a schematic diagram illustrating functional blocks of a sound effect power supply configuration according to the present invention.

### DETAILED DESCRIPTION OF THE PREFERRED EMBODIMENT

Reference will now be made in detail to an embodiment of the present invention, examples of which are illustrated in the accompanying drawings.

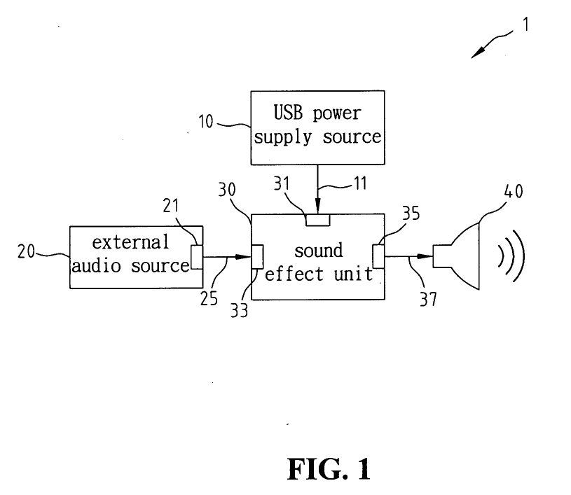

Referring to FIG. 1, a schematic diagram illustrating a sound effect power supply configuration according to the present invention is shown. As illustrated in FIG. 1, the sound effect power supply configuration 1 according to the present invention includes a USB power supply source 10, an external audio source 20, a sound effect unit 30, and an external speaker 40, wherein the USB power supply source 10 may be a USB port, such as a USB port of a game machine, a cell phone, a personal computer or a laptop computer, and the USB power supply source 10 provides a USB power source 11. According to USB specification, the USB power 11 may be between 4.75V and 5.25V or between 4.4V and 5.25V.

The external audio source 20 has a function of playing speech sound or music, such as an MP3 player, a cell phone, a CD player, and a DVD player. The external audio source 20 has an audio signal terminal 21, for outputting an audio signal 25.

The sound effect unit 30 has a USB power input terminal 31, an audio input terminal 33, an audio output terminal 35, and a plurality of audio blocks (not shown). The USB power input terminal 31 receives the USB power source 11 for using as a power supply source of the audio blocks. The audio input terminal 33 receives the audio signal 25 from the external audio source 20. The audio output terminal 35 outputs an audio output signal 37 which generated by the sound effect unit 30 after processing by the audio blocks. The external speaker 40 receives the audio output signal 37 of the sound effect unit 30, and generates sounds.

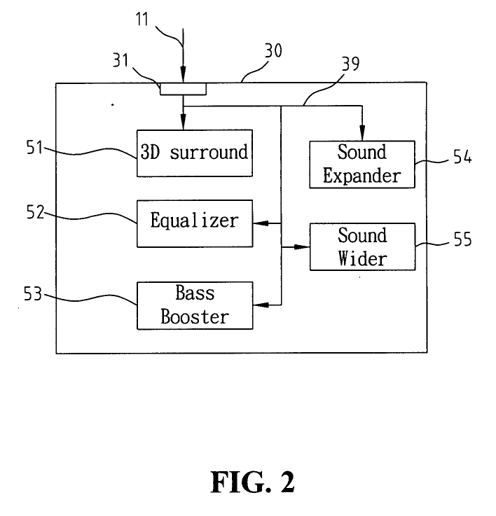

Referring to FIG. 2, a schematic diagram illustrating functional blocks of a sound effect power supply configuration according to the present invention is shown. As illustrated in FIG. 2, the USB power source input terminal 31 of the sound effect unit 30 transmits an internal USB power source 39, and the sound effect unit 30 includes at least one of a 3D Surround 51, an Equalizer 52, a Bass Booster 53, a Sound Expander 54, and a Sound Wider 55, wherein the 3D Surround 51, the Equalizer 52, the Bass Booster 53, the Sound Expander 54, and the Sound Wider 55 may receive the internal USB power source 39 as a power supply source.

As known from FIGS. 1 and 2, users may obtain power by receiving USB power source 11 of USB power supply source 10 using sound effect unit 30, and may further audio process the audio signal 25 of the external audio source 20 by sound effect unit 30, such as 3D surround, equalization, bass boost, sound expansion or sound amplification, and drive the external speaker 40 to generate sounds having high quality sound effect in the end. Hence, the present invention provides users enable to conveniently play the external signal 25 of the external audio source 20 through the external speaker 40, for USB port is a necessary input/output interface in many electronic products and is easy to acquire.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A sound effect power supply configuration comprising:
a USB (Universal Serial Bus) power supply source that provides a USB power source;
an external audio source having an audio signal terminal which outputs an audio signal;
a sound effect unit comprising:
a USB power input terminal, connecting to the USB power supply source, for receiving the USB power and providing the audio blocks said USB power as a power supply source;
an audio input terminal, receiving audio signals from the external audio source;
an audio output terminal, outputting an audio output signal which generated by the sound effect unit after processing by the audio blocks; and
a plurality of audio blocks; and
an external speaker having an audio input terminal, which connects to the audio output terminal of the audio unit, for receiving the audio output signal of the audio unit and generating sounds.

2. The sound effect power supply configuration of claim 1, wherein the USB power is between 4.75V and 5.25V

3. The sound effect power supply configuration of claim 1, wherein the USB power is between 4.4V and 5.25V.

4. The sound effect power supply configuration of claim 1, wherein the external audio source comprises at least one of an MP3 (MPEG 1 Layer 3) player, a cell phone, a CD (compact disk) player and a DVD (digital versatile disc) player.

5. The sound effect power supply configuration of claim 1, wherein the plurality of audio blocks of the audio unit comprises at least one of a 3D (3 Dimensional) surround, a sound expander, an equalizer, a bass booster, and a sound wider.
